(19) United States
(12) Patent Application Publication
(10) Pub. No.: US 2007/0248807 A1
(43) Pub. Date: Oct. 25, 2007

(54) Impact protection structure

(76) Inventors: David M. Kaschak, Olmsted Falls, OH (US); Thomas E. Biller, Brunswick, OH (US); Mark Segger, Strongsville, OH (US)

Correspondence Address: WADDEY & PATTERSON, P.C., 1600 DIVISION STREET, SUITE 500, NASHVILLE, TN, 37203, US

(21) Appl. No.: 11/406,841

(22) Filed: Apr. 19, 2006

(51) Int. Cl. B32B 3/00

(52) U.S. Cl. 428/312.2

(57) ABSTRACT

An impact protection structure useful for protecting against an impact, includes a carbon foam having a ratio of compressive strength to density of at least about 1000 psi/(g/cc) and a internal cell structure for absorbing and dissipating the kinetic energy of an impact.

### BACKGROUND OF THE INVENTION

1. Technical Field

The present invention relates to high strength carbon foams useful for creating impact protection structures. More particularly, the present invention relates to carbon foams exhibiting improved strength, weight and density characteristics in providing a lightweight structure for protection from shock pressure and fragmented materials while being resistant to both chemical and thermal degradation.

2. Background Art

With terrorism becoming more recognized as a threat to both soldiers and civilians, there is an increasing need to provide protection from the impact of both explosions and projectiles. One of the greatest causes of the loss of life is the detonation of an explosive device in the proximity of inadequately protected vehicles, buildings or persons.

Protective structures, armors, are the usual method of providing protection against the detonation of an explosive device. Often, armor consists of thick metal layers to protect against both the impact and the projectiles of an explosive device. However, this style of armor is quite dated, as it is both extremely heavy and difficult to install in existing structures.

Improvements have been made over thick metal plating, providing improved fracture resistance, chemical resistance, and machineability. Of particular improvement is armor which is less heavy than traditional metal plate armor. A standard improved armor system consists of a rigid striking surface and metallic backing plate. Often the rigid striking surface is a ceramic structure which absorbs and dissipates the stress of the impact, projectile-impact or both throughout the armor. The metallic backing plate precludes penetration of the projectile and ceramic fragments, though it may experience significant deformation.

The ceramic structure/metal backing plate protective systems do afford protection at a reduced weight, making this arrangement more attractive for vehicular and personnel armor. They are not, however, ideal for absorbing the shockwave from a blast or the shock generated by projectile impact. Many inventions have attempted to maintain light weight characteristics while possessing improved energy absorption characteristics. For example, Clausen (U.S. Pat. No. 4,186,648) teaches of a woven laminate structure of polyester resin fibers supported within a resin-type matrix.

In Dunn (U.S. Pat. No. 5,349,893), an impact absorbing armor is disclosed where the armor is comprised of multiple cells to distribute the kinetic energy of a projectile. This arrangement of polygon cells is incorporated with a primary resistant outer layer of which the projectile will strike first.

In U.S. Pat. No. 6,532,857, Shih et al. describes an armor comprising an elastomer plate with isolated ceramic tiles that can be sized to variety of shapes. The invention is lightweight and can be attached through either adhesive or bolting means.

Cohen (U.S. Pat. No. 6,575,075) discloses a composite armor plate for absorbing and dissipating kinetic energy comprising an internal layer of pellets bound and retained in a plate form.

U.S. Pat. No. 6,705,197, Neal, describes a lightweight fabric-based armor of a combination of different types of ballistic fabrics incorporated together. The different fabric serve to slow and deform a projectile and also absorb its energy.

In Chu et al. (U.S. Pat. No. 6,679,157) an armor system is described where a graded metal matrix composite layer is created through thermal spray deposition. The composite had an increasing amount of ceramic particles with a ceramic impact layer covering the composite layer.

Yu et al. (U.S. Pat. No. 6,698,331) incorporates a metallic foam in a multi-layer armor system as a shock-absorbing element.

Unfortunately, impact protection structures produced by the prior art processes are not completely effective for many protection applications requiring superior strength to density characteristics, chemical resistance, flame resistance, and ease of machineability. Most prior art armor does not have the strength and strength to density requirements for applications where excess weight cannot be tolerated. In addition, many prior art structures lack the ability to absorb multiple impacts, either shattering or experiencing structural degradation to the point where open-celled foams with highly interconnected pores have porosities making them ill-suited for such applications.

What is desired is a light-weight impact protection structure which has controllable structural characteristics, where the physical structure, strength and strength to density ratio make the impact protect structure suitable for a wide variety of applications including vehicular, personnel armor and building protection as well as barrier structures designed for vehicular impact. Furthermore, an impact protection structure is desirable which resists thermal degradation as well as chemical attacks. Indeed, a combination of characteristics, including strength to density ratios higher than contemplated in the prior art, have been found to be necessary for improved impact protection structures. Also desired is a process for preparing such structures.

### SUMMARY OF THE INVENTION

The present invention provides a impact protection structure which is uniquely capable of use in a variety of impact protection applications including vehicular and personnel armor and also building protection. The inventive impact protection structure comprises a carbon foam core which exhibits density, compressive strength and compressive strength to density ratios to provide a combination of strength and relatively light weight characteristics not heretofore seen. In addition, the monolithic nature and controllable cell structure of the foam, with a combination of larger and smaller pores, which are relatively spherical, provide a carbon foam which can be produced in a desired size and configuration and which can be readily machined for the desired impact protection application.

More particularly, the carbon foam of the inventive impact protection structure, has a density of about 0.03 to about 0.6 grams per cubic centimeter (g/cc), preferably with a compressive strength of at least about 2000 pounds per square inch (psi) (measured by, for instance, ASTM C695).

Furthermore, the carbon foam of the impact protection structure should have a relatively uniform distribution of pores in order to provide the required high compressive strength. In addition, the pores should be relatively isotropic, by which is meant that the pores are relatively spherical, meaning that the pores have, on average, an aspect ratio of between about 1.0 (which represents a perfect spherical geometry) and about 1.5. The aspect ratio is determined by dividing the longer dimension of any pore with its shorter dimension.

The foam should have a total porosity of about 65% to about 95%, more preferably about 70% to about 95%. In addition, it has been found highly advantageous to have a bimodal pore distribution, that is, a combination of two average pore sizes, with the primary fraction being the larger size pores and a minor fraction of smaller size pores. Preferably, of the pores, at least about 90% of the pore volume should be the larger size fraction, and at least about 1% of the pore volume should be the smaller size fraction.

The larger pore fraction of the bimodal pore distribution in the inventive carbon foam should be about 10 to about 150 microns in diameter. The smaller fraction of pores should comprise pores that have a diameter of about 0.8 to about 3.5 microns. The bimodal nature of the inventive foams provide an intermediate structure between open-celled foams and closed-cell foams, thus limiting the liquid permeability of the foam while maintaining a rigid foam structure.

To produce the carbon foam for use in a impact protection structure a polymeric foam block, particularly a phenolic foam block, is carbonized in an inert or air-excluded atmosphere, at temperatures which can range from about 500° C., more preferably at least about 800° C., up to about 3200° C. Alternatively, carbon foams can be prepared by the thermal treatment of mesophase pitches under high pressure.

An object of the invention, therefore, is a impact protection structure with a carbon foam core having the density, compressive strength and ratio of compressive strength to density sufficient for various impact protection applications.

Still another object of the invention is an impact protection structure with a carbon foam core, the carbon foam having porosity and cell structure to facilitate an increase in rigidity and localized fractures upon impact.

Yet another object of the invention is an impact protection structure with a carbon foam core which can be produced in a desired size and configuration, and which can be readily machined or joined to provide larger protective structures.

Yet another object of the invention is an impact protection structure with a carbon foam core which is resistant to chemical agents.

Still another object of the invention is an impact protection structure with a carbon foam core which maintains integrity and resists combustion when exposed to high temperatures or open flames.

An additional object of the invention is an impact protection structured with a carbon foam core designed for use in barrier protection applications.

Another object of the invention is to provide a method of producing the impact protection structure with a carbon foam core.

These aspects and others that will become apparent to the artisan upon review of the following description can be accomplished by providing impact protection structure including a carbon foam core having a ratio of compressive strength to density of at least about 1000 psi/(g/cc), and more preferably at least about 7000 psi/(g/cc), with an upper limit of about 20,000 psi/(g/cc). The impact protection structure's carbon foam core advantageously has a density of from about 0.03 to about 0.6, more preferably about 0.05 to about 0.4, and a porosity of between about 65% and about 95%. The pores of the carbon foam have, on average, an aspect ratio of between about 1.0 and about 1.5.

The carbon foam of the impact protection structure can be produced by carbonizing a polymer foam article, especially a phenolic foam, in an inert or air-excluded atmosphere. The phenolic foam should preferably have a compressive strength of at least about 100 psi. Alternatively, the carbon foam can be prepared by the thermal treatment of mesophase pitch under high pressure.

It is to be understood that both the foregoing general description and the following detailed description provide embodiments of the invention and are intended to provide an overview or framework of understanding to nature and character of the invention as it is claimed.

### DETAILED DESCRIPTION OF THE PREFERRED EMBODIMENTS

The key constituent of the inventive impact protection structure is the carbon form core. Carbon foams in accordance with the present invention are prepared from polymeric foams, such as polyurethane foams or phenolic foams, with phenolic foams being preferred. Phenolic resins are prepared by the reaction of phenol or substituted phenol with an aldehyde, especially formaldehyde, in the presence of an acidic or basic catalyst. Phenolic resin foam is a cured system composed of open and closed cells.

The polymeric foam used as the starting material in the production of the inventive carbon foam should have an initial density which mirrors the desired final density for the carbon foam which is to be formed. In other words, the polymeric foam should have a density of about 0.03 to about 0.6 g/cc, to obtain a carbon foam with a density of from about 0.03 to about 0.6 g/cc. The cell structure of the polymeric foam should be closed with a porosity of between about 65% and about 95% and a relatively high compressive strength, i.e., on the order of at least about 100 psi, and as high as about 300 psi or higher. Alternatively, the cell structure can be open, though the relatively high compressive strength of the carbon foam is diminished.

In order to convert the polymeric foam to carbon foam, the foam is carbonized by heating to a temperature of from about 500° C., more preferably at least about 800° C., up to about 3200° C., in an inert or air-excluded atmosphere, such as in the presence of nitrogen. The heating rate should be controlled such that the polymer foam is brought to the desired temperature over a period of several days, since the polymeric foam can shrink by as much as about 50% or more during carbonization. Care should be taken to ensure uniform heating of the polymer foam piece for effective carbonization.

By use of a polymeric foam heated in an inert or air-excluded environment, a carbon foam is obtained, which has the approximate density of the starting polymer foam, a ratio of strength to density of at least about 1000 psi/(g/cc), more preferably at least about 7000 psi/(g/cc) with upper limits around about 20,000 psi/(g/cc). The carbon foam should also have a relatively uniform distribution of isotropic pores having, on average, an aspect ratio of between about 1.0 and about 1.5, required for the relatively high compressive strength.

The resulting carbon foam has a total porosity of about 65% to about 95%, more preferably about 70% to about 95% with a bimodal pore distribution; at least about 90% of the pore volume of the pores are about 10 to about 150 microns in diameter, while at least about 1% of the pore volume of the pores are about 0.8 to about 3.5 microns in diameter. The bimodal nature of the inventive foam provides an intermediate structure between open-celled foams and closed-cell foams, limiting the liquid permeability of the foam while maintaining a foam structure.

Typically, characteristics such as porosity and individual pore size and shape are measured optically, such as by use of an epoxy microscopy mount using bright field illumination, and are determined using commercially available software, such as Image-Pro Software available from MediaCybernetic of Silver Springs, Md.

By varying the composition and structure of the starting phenolic foam, a carbon foam can be created tailored specifically to the environment in which the impact protection structure will be applied. Energy absorption characteristics of the impact protection structure can be tailored by adjusting the phenolic foam's density, porosity, bimodal nature, cell size, and degree of open versus closed cells. Moreover, the exact porosity can be created for the desired type of protection, whether the threat is an explosive device or a bullet-type projectile. Different variations of open and closed cell porosity as well as pore sizes create a carbon foam which performs best for a specific type of impact.

Tailoring of the impact protection structure's carbon foam begins with the creation of the resins which are used to form the phenolic foam. Generally, the resins are aqueous resols catalyzed by sodium hydroxide at a formaldehyde-to-phenol ratio which can vary, but is preferably about 2:1. The phenolic foam is then prepared by adjusting the water content of the resin and by adding a surfactant (e.g., an ethoxylated nonionic), a blowing agent (e.g., pentane, methylene chloride, or chlorofluorocarbon), and a catalyst (e.g., toluenesulfonic acid or phenolsulfonic acid). The sulfonic acid catalyzes the reaction, while the exotherm causes the blowing agent, emulsified in the resin, to evaporate and hence expand the foam.

The surfactant is responsible for controlling the cell size as well as the ratio of open-to-closed cell units within the phenolic foam, and the resulting carbon foam upon carbonization of the phenolic foam. Thus by selection of the surfactant, and close monitoring of the foaming process, a specific porosity can be achieved including foams which are open-celled, close-celled or bimodal while also dictating the actual size of the pores.

While the preferred phenol is resorcinol, other phenols of similar kind can be use to form condensation products with aldehydes. Such phenols include monohydric and polyhydric phenols, pyrocatechol, hydroquinone, alkyl-substituted phenols, such as, for example, cresols or xylenols, polynuclear monohydric or polyhydric phenols, such as, for example, naphthols, p.p′-dihydroxydiphenyl dimethyl methane or hydroxyanthracenes. Selection of different phenols can result in different density and strength characteristics of the carbon foam upon the foaming and carbonization steps.

The preferred aldehyde for use in the solution is formaldehyde. Other suitable aldehydes include those that will react with phenols in the same manner. These include, for example, acetaldehyde and benzaldehyde which also have differing molecular weights and will result in a modified resin.

In general, the phenols and aldehydes that can be used in the process of the invention are those described in U.S. Pat. Nos. 3,960,761 and 5,047,225, the disclosures of which are incorporated herein by reference.

Furthermore, the impact protection structure can have even more improved strength characteristics through reinforcement of the carbon foam. In order to create a reinforced carbon foam with improved strength properties, the carbon foam should be prepared with carbon fibers, carbon nanotubes and carbonized phenolic micro-balloons, incorporated throughout the foam's structure. The particular type of carbon fibers for improving the strength of the carbon foam include carbon fibers derived from PAN, isotropic pitch, and mesophase pitch. Furthermore, carbon nanotubes also will improve the strength of the foam.

The preferred method for creating reinforced carbon foam for impact protection structures is by incorporating carbon fibers into the initial liquid resol resin. Optimally, the liquid resol resin will have a water content of about 10% to about 30% by weight and the carbon fibers will have a length of about 0.1 inch to about 1.0 inch. Typically, the carbon fibers are added to the liquid resol resin in carbon fiber bundles under room temperature conditions. Each bundle consists of approximately 2,000 to 30,000 individual carbon fiber filaments held together in the tow form with a polymer resin or a sizing agent. For the most effective reinforcement and the greatest uniformity in properties of the carbon foam, the carbon fiber bundles need to be separated into individual filaments and dispersed throughout the carbon foam's structure. Optimally, the resin used in holding the carbon fiber bundles is water soluble and will readily dissolve upon addition to the liquid resol resin, allowing for the dispersion of individual carbon fiber filaments.

The carbon fiber bundles adhered with a water-soluble resin, can be added from about 0.5% to about 10% by weight to the liquid resol phenolic resin. This percentage range will optimally increase the strength and graphitic properties of the foam while not substantially reducing the inherent desirable properties of phenolic resin-derived carbon foam. Upon addition of the carbon fiber bundles to the liquid resol resin, the individual carbon fiber filaments will disperse throughout the resin and provide an ideal carbon fiber-resin mixture for the subsequent foaming process. Through foaming the phenolic resin, the carbon fiber will become uniformly dispersed and fixed in a specific spatial orientation within the phenolic foam product, prior to the aforementioned carbonization process.

The impact protection structure's carbon foam core allows for significant energy absorption with minimal chance of structural failure. Upon impact with either a projectile or shock wave, the carbon foam core experiences a deformation at the point of impact. The inherent properties of the foam structure allow for the carbon foam to fracture only at the point of impact and rapidly disperse the kinetic energy of the impact rather than the impact protection structure experience total failure or, even worse, transmit the energy to the area of desired protection.

Specifically, the energy from either the projectile impact or shockwave will impact and compress the frontal portion of the carbon foam core, essentially creating a localized densification of the carbon foam. If the kinetic energy is great enough, the individual cells of the carbon foam will fracture, thus dissipating the kinetic energy laterally throughout the impact protection structure. Furthermore, the increased porosity provides an extended and connected pore arrangement which efficiently disperses the kinetic energy through and around the voids within each cell. Effectively, the connected pores scatter the blast wave laterally through the network of the carbon foam, thus significantly reducing the amount of energy transmitted through the impact protection structure to the desired area of protection.

Furthermore, impact protection structures including a carbon foam core possess an increased chemical resistance when compared to other forms of armor protection. Carbon foam is essentially inert, reacting only with oxidizing agents at elevated temperatures. Corrosive chemicals, including extreme pH chemical agents as well as metallic substances have little effect on carbon foam.

Yet furthermore, carbon foam is an extremely hard substance, lending itself poorly to insect habitation while its chemical and structural properties are virtually not altered by a change in humidity. As such, impact protection structures incorporating carbon foam do not have to be tailored to nature's elements. Additionally, carbon foam is quite fire retardant, and will not combust in high temperature environments or upon exposure to an open flame.

In another embodiment, an additional element of the impact protection structure is a carbon foam retention sheet situated behind the carbon foam and in between the carbon foam and the area to which protection is desired. This contact surface is characterized as the support surface, the side opposite of the carbon foam's impact surface, and is in also in a closer proximity to the desired protection area than the impact surface. Such retention sheet should be deformable, allowing slight flex upon impact on the carbon foam. The carbon foam retention sheet may comprise a malleable metal or layer of metals, a variety of polymer composites, ballistic fabrics, or a combination of any of the above.

Optionally, the impact protection structure may contain an initial impact shield situated on the surface of the carbon foam opposite to the carbon foam retention sheet, this surface of the carbon foam characterized as the impact surface. The initial impact shield would receive the impact prior to the carbon foam and preferably is formed of a strong rigid material. This shield functions also to dissipate the impact and is most useful in protecting against projectiles. Upon contact by a bullet-type projectile the initial impact shield acts to spread the kinetic energy across a greater surface area of the carbon foam when compared to the projectile impacting the carbon foam core without an initial impact shield. Essentially, the initial impact shield propagates the kinetic energy of a projectile to a larger degree of cells of the carbon foam, allowing for a larger lateral movement of the kinetic energy and also if the impact necessitates, a larger fracture area of the carbon foam cellular network. The initial impact shield, with its rigid structure, is also better suited for deflecting impacts coming from an angle than the carbon foam surface. Finally, use of an initial impact shield provides an enhanced protection against projectiles while also allowing for a smaller quantity of the carbon foam core to be utilized in the impact protection structure. This shield may be comprised of ceramics, metals, ceramic-metal composites, polymer composites, or combinations thereof

The impact protection structure with carbon foam may be used to protect a plurality of subjects. With the extremely high strength to density ratio of carbon foam, this impact protection structure is ideal for both vehicles and personnel where excess weight can be detrimental. The impact protection structure can also be easily machined and sized making the invention desirable for retrofitting existing buildings for impact protection.

In an alternative embodiment, the impact protection structure can be designed as a barrier for the collision of vehicles. For instance, in race track applications, carbon foam impact protection structures can be utilized to reduce injury to drivers by way of the structures' high impact absorption capabilities while precluding injury to the fans. Furthermore, the low flammability and resistance to thermal degradation as well as carbon foam's light weight and ease of molding, make carbon foam impact protection structures ideal for such applications. In the case of a vehicular collision the absorptive nature of the carbon foam impact protection structure allows for reduced damage to the vehicle while the structure can be quickly replaced to minimize any race delays.

Accordingly, by the practice of the present invention, impact protection structures having heretofore unrecognized characteristics are prepared. These structures containing carbon foam, exhibit exceptionally high compressive strength to density ratios, and have a distinctive bimodal cell structure, making them uniquely effective for forming impact protection structures where kinetic energy must be quickly absorbed and dissipated

The disclosures of all cited patents and publications referred to in this application are incorporated herein by reference.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed is:

1. An impact protection structure comprising a carbon foam with oppositely positioned impact surface and support surface, wherein the carbon foam absorbs kinetic energy applied to the initial contact surface and dissipates at least some of the energy in the carbon foam.

2. The impact protection structure of claim 1 wherein the carbon foam has a density of from about 0.03 g/cc to about 0.6 g/cc.

3. The impact protection structure of claim 1 wherein the carbon foam material has a ratio of compressive strength to density of at least about 1000 psi/(g/cc).

4. The impact protection structure of claim 1 wherein the carbon foam has a porosity of from about 65% to about 95%.

5. The impact protection structure of claim 1 which further comprises a carbon foam retention sheet in contact with the support surface of the carbon foam.

6. The impact protection structure of claim 5 wherein the carbon foam retention sheet is selected from the group consisting of polymer composites, metals, fabrics, or combinations thereof.

7. The impact protection structure of claim 1 wherein the carbon foam material is a reinforced carbon foam material.

8. The impact protection structure of claim 7 wherein the reinforced carbon foam material is prepared with reinforcements selected from the group consisting of mesophase pitch carbon fibers, isotropic pitch carbon fibers, carbonized rayon fibers, carbonized cotton fibers, polyacrylonitrile-based (PAN) carbon fibers, cellulose fibers, carbon nanofibers, carbon nanotubes, and combinations thereof.

9. The impact protection structure of claim 1 further comprising an initial impact shield in contact with the impact surface of the carbon foam.

10. The impact protection structure of claim 9 wherein the initial impact shield is selected from the group consisting of ceramics, metals, ceramic-metal composites, polymer composites, and combinations thereof.
